(19) United States
(12) Patent Application Publication
(10) Pub. No.: US 2026/0333019 A1
(43) Pub. Date: Oct. 22, 2026

(54) SYSTEM AND METHOD FOR ESIM PROFILE LIFECYCLE ORCHESTRATION USING A COMMON POOL WITH VOUCHER ACTIVATION AND OWNERSHIP TRANSFER

(71) Applicant: Nishi Kant, Pleasanton, CA (US)

(72) Inventor: Nishi Kant, Pleasanton, CA (US)

(21) Appl. No.: 19/537,560

(22) Filed: Feb. 12, 2026

Related U.S. Application Data
(63) Continuation-in-part of application No. 19/439,371, filed on Jan. 4, 2026.

(51) Int. Cl. H04W 8/20; G06K 19/06

(52) U.S. Cl. CPC H04W 8/205; G06K 19/06037

(57) ABSTRACT

A backend orchestration system dynamically manages eSIM profile deployment across multiple SM-DP+ platforms. It enables bulk procurement decoupled from devices/users and maintains logical metadata pools for allocation. Supports hybrid consumer activation (direct on-demand QR codes and pre-printed vouchers with runtime late binding via ConfirmOrder on ES11 discovery query from pending pool). For IoT, enterprise-specific logical pools enable multi-tenant ownership transfer—allowing device manufacturer to procure unbound bootstrap profiles and transfer references/metadata to downstream utility without re-preparation. Orchestrator provides utility's eIM metadata for final binding (ConfirmOrder) and remote triggers. System avoids storing cryptographic keys, uses GSMA-standard interfaces, and includes cross-vendor analytics/adaptive policy to optimize inventory, minimize lock-in, and support local operational profiles for regulatory compliance

### CROSS-REFERENCE TO RELATED APPLICATIONS

This application is a continuation-in-part of U.S. patent application Ser. No. 19/439,371, filed Jan. 4, 2026, entitled “System and Method for Dynamic eSIM Orchestration Across Multi Vendor Platforms,” the entire disclosure of which is incorporated herein by reference.

### STATEMENT REGARDING FEDERALLY SPONSORED RESEARCH OR DEVELOPMENT

The invention described herein was not made under federally sponsored research or development. No government rights apply

### REFERENCE TO SEQUENCE LISTING, LARGE TABLE, OR COMPUTER PROGRAM LISTING APPENDIX

Not applicable.

### FIELD OF THE INVENTION

The present invention relates generally to the field of software automation in telecommunications and, more particularly, to systems and methods for managing remote SIM provisioning (RSP) for embedded subscriber identity module (eSIM) profiles across consumer and Internet-of-Things (IoT) devices. The invention extends the capabilities of a neutral orchestration layer to support both hybrid consumer activation—covering real-time on-demand QR codes and pre-printed voucher workflows—and multi-tenant ownership transfer of profile references along an IoT supply chain.

### BACKGROUND OF THE INVENTION

Under the GSM Association (GSMA) specifications for consumer devices (SGP.22) and IoT devices (SGP.32), encrypted eSIM profile packages are stored on Subscription Manager Data Preparation Plus (SM-DP+) servers. Operators procure profile inventory from multiple vendors and each vendor operates its own SM-DP+ server with a separate pool of identifiers e.g., Integrated Circuit Card Identifiers (ICCID)s, International Mobile Subscriber Identities (IMSI)s and associated cryptographic keys. When operators purchase eSIM stock from multiple vendors, the inventory becomes fragmented across pools. Today operators route customer orders to specific SM-DP+ servers using static rules (e.g. device type, access method, region etc.) or ICCID ranges, which can exhaust some pools while leaving others underutilized. Subscriber records are often provisioned in the Home Subscriber Server/Unified Data Manager (HSS/UDM) in anticipation of profile downloads, consuming licensing resources even if the profiles remain unused. In case of IoT devices, the global distribution often requires getting access to eSIM profiles from local operators due to regulatory or policy reasons, it remains a challenge that each enterprise is left to solve for itself as device transitions from bootstrap profile to operational one and ownership transfers from manufacturer enterprise customer.

Several drawbacks arise from this static allocation model: (a) pool exhaustion and under-utilization of other pools; (b) poor customer experience or loss of customers during period of high demand if the associated SM-DP+ is exhausted (c) vendor lock-in caused by routing orders to particular SM-DP+ servers; (d) inefficiency from pre-provisioning subscriber records before profiles are allocated; and (e) fragmentation between consumer and IoT RSP flows. Prior art includes meta-RSP platforms that aggregate multiple vendors but require device-side selection (e.g., U.S. Pat. No. 10,939,268) and remote provisioning nodes focused on dynamic profile generation (e.g., US 2019/0181901 A1). These systems either rely on device-side selection or treat each SM-DP+ server separately and do not create a unified logical pool accessible through a single backend interface. There remains a need for a backend orchestration layer that virtualizes multiple SM-DP+ inventories into a logical pool, enables late binding of vendor choice and deferred HSS/UDM provisioning, and unifies consumer and IoT workflows.

The parent application, incorporated herein by reference, addresses logical pooling and decoupling. However, there remains a need for runtime dynamic allocation in pre-printed consumer QR vouchers via compliant Subscription Management Discovery Server (SM-DS) discovery and multi-tenant transfer of profile references in IoT supply chains without re-preparation.

### SUMMARY OF THE INVENTION

The invention provides a neutral orchestration layer (the “orchestrator”) that interfaces with multiple vendor-operated SM-DP+ servers and an IoT remote manager (eIM) to create a unified logical pool of eSIM profiles. The orchestrator may receive bulk profile procurement request from its own or external portal, CRM, BSS or similar systems. Based on policy rules (e.g. inventory availability, device type, region, ongoing promotion, access method, cost or service-level agreements), the orchestrator selects one or more SM-DP+ servers dynamically. It uses DownloadOrder command to allocate batches of profiles at the selected SM-DP+ servers and ConfirmOrder command to bind the profile to a device at the right time. Instead of storing encrypted profile payloads or keys, the orchestrator records metadata for each allocated profile—such as profile type, server (SM-DP+) identifier, order identifier, batch number and availability status—into a logical pool. Procurement timing is decoupled from deployment timing, allowing operators or enterprises to stock inventory in advance without needing to make deployment time decisions upfront, such as assigning profiles to specific devices or subscribers. The eSIM profiles created at the time of procurement are in pending (unbound) state so that they can be bound to a specific device's eUICC identifier (EID). In case of IoT, orchestrator may create dedicated pools for each enterprise customer and enterprise's deployment orders use profiles created through bulk orders for that enterprise.

Upon receiving a eSIM deployment request from a consumer device through business support system (BSS) or customer relationship management (CRM) system, discovery server (SM-DS) or from its own portal, the orchestrator dynamically selects an SM-DP+ server according to policy and allocates a profile from that server. The orchestrator also issues a ConfirmOrder to the SM-DP+ server with the EID received in the deployment request. Subsequently, the orchestrator constructs an activation code by concatenating the selected SM-DP+ fully qualified domain name (FQDN) with the matching identifier and returns a QR code to the requesting system for delivery to the customer. Orchestrator then triggers subscriber provisioning in the HSS/UDM only after the profile is allocated, reducing unused subscriber records.

For headless IoT devices, deployment requests are received from an eSIM IoT Manager (eIM) where these IoT devices are registered. Alternatively, the deployment request can come to orchestrator from enterprise portal or other systems as long as the orchestrator has been provided with the information about eIM that is associated with the IoT devices. The orchestrator selects an SM-DP+ server using the similar policy rules and returns metadata (e.g., SM-DP+ FQDN, profile type, regional restrictions and policy flags) to the eIM. The eIM issues a ConfirmOrder to the selected SM-DP+ server over the GSMA-defined ES2+ with EID to bind the profile to the device and then manages device-side interactions such as messages over the GSMA-defined ESipa interface. The orchestrator does not communicate with the IoT device; it only manages bulk procurement, policy-based selection of SM-DP+ servers, profile ownership change among entities and HSS/UDM provisioning. When IoT devices must switch from a globally loaded bootstrap profile to a locally compliant operational profile due to regulatory requirements, the orchestrator coordinates the procurement of local profiles and ensures a seamless transition through coordination with eIM.

Additional features include cross-vendor analytics and adaptive policy updates. The orchestrator aggregates statistics across vendors, such as success rates, latency, error codes and inventory consumption. It applies analytics to adjust policy weights (e.g., preferring vendors with lower latency or cost) and generates alerts when inventory levels fall below thresholds. The orchestrator also distinguishes between bulk procurement orders and deployment orders, allowing enterprises to pre-reserve inventory for large IoT deployments via reference identifiers and to dynamically source profiles when reserved pools are depleted. The orchestrator may be hosted by a trusted third party and aggregate SM-DP+ platforms from multiple mobile network operators or mobile virtual network operators, providing enterprises with a single interface for procuring profiles across heterogeneous providers and scoping pools via reference identifiers to specific projects.

This continuation-in-part extends the parent system to hybrid consumer activation workflows and multi-tenant IoT supply-chain handover. In pre-printed consumer voucher scenarios, bulk profile procurement requests optionally include a GSMA-compliant Subscription Manager Discovery Server (SM-DS) FQDN and shared EventID. The orchestrator issues these to selected multi-SM-DP+ servers; compliant SM-DP+ servers automatically register event records via ES12 to the specified SM-DS. Static QR codes printed on vouchers encode the SM-DS FQDN and shared EventID. Upon customer scan, the device's Local Profile Assistant (LPA) initiates an ES11 event retrieval to the SM-DS with the EventID and EID. The SM-DS (optionally a thin GSMA-compliant front-end with an internal API to the orchestrator) matches registered records and invokes the orchestrator's policy engine to select an optimal SM-DP+ record from the multi-registered options. The orchestrator selects an SM-DP+ and issues ConfirmOrder with EID and other metadata so that the SM-DP+ can create a bound profile for this device. The orchestrator then responds to the SM-DS with the selected SM-DP+ FQDN and matching identifier which SM-DS provides to the device. The LPA in the device then downloads the profile from the selected SM-DP+ server via ES8+/ES9+. The orchestrator can then initiate the HSS/UDM provisioning for this profile. This opt-in (printed batches only) approach preserves direct online paths, enables runtime dynamism for vouchers and shares the same logical pool and analytics as online activations—designed to operate in accordance with GSMA SGP.22 via attested ES12 provenance.

In multi-tenant IoT supply-chain handover scenarios, a device maker or manufacturer (as enterprise tenant or customer) uses the orchestrator portal to order unbound bootstrap profiles and embedded universal integrated circuit card (eUICC) hardware. The orchestrator issues DownloadOrder commands to selected multi-vendor SM-DP+ servers, prepares unbound bootstrap profiles and stores metadata and references (e.g., EID/ICCID manifest, batch number, initial eIM) in a virtual pool. At a manufacturing facility, the device maker integrates the eUICC with the device and loads the bootstrap profile. Completed devices are shipped to a downstream enterprise such as a utility. The device manufacturer issues a transfer order via the portal; the orchestrator onboards the downstream enterprise as a new tenant or customer and transfers the bootstrap profile references and associated metadata to the new entity's logical pool without re-preparing or moving the underlying profile payloads. When the utility deploys devices, they register via the bootstrap profile with the initial eIM. The utility orders operational profiles through the portal; the orchestrator selects an SM-DP+ server based on policy, allocates a pending operational profile and stores metadata in the logical pool. It transmits the operational metadata to the utility's eIM, which issues a ConfirmOrder using the device's EID to bind the operational profile and sends a DownloadTrigger; the device downloads and installs the operational profile and switches to local connectivity. The selected operational profile could be from a local operator if the policy or regulatory requirement says so. This seamless handover from manufacturer bootstrap to utility operational profiles decouples supply-chain participants, eliminates redundant profile preparation and addresses the regulatory requirement to obtain locally compliant profiles.

### BRIEF DESCRIPTION OF THE DRAWINGS

FIG. 1-6 are the same as in parent application

FIG. 7 illustrates hybrid consumer activation with pre-printed QR voucher via SM-DS discovery.

FIG. 8 illustrates ownership transfer of eSIM profile among entities in a multi-tenant setup at Orchestrator

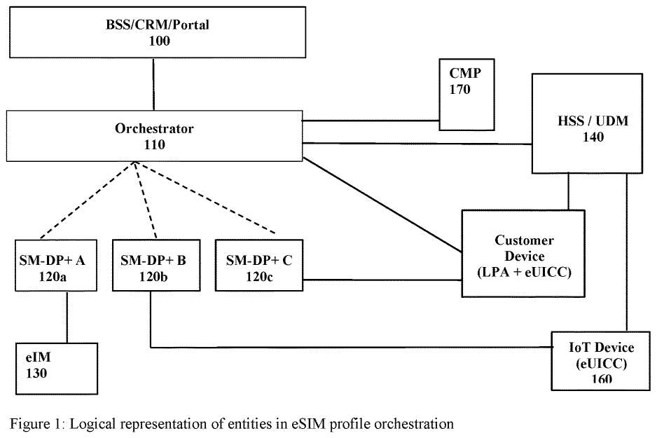

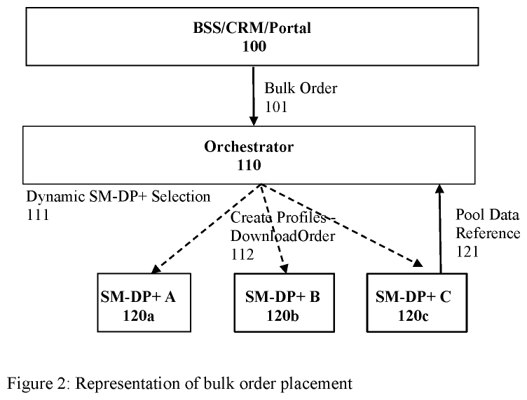

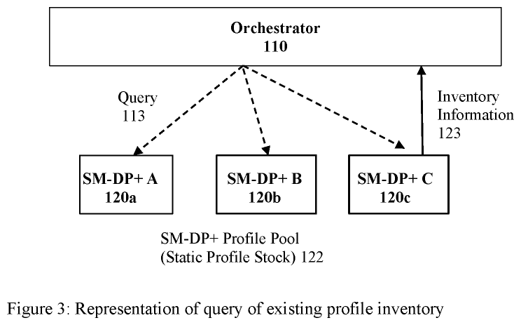

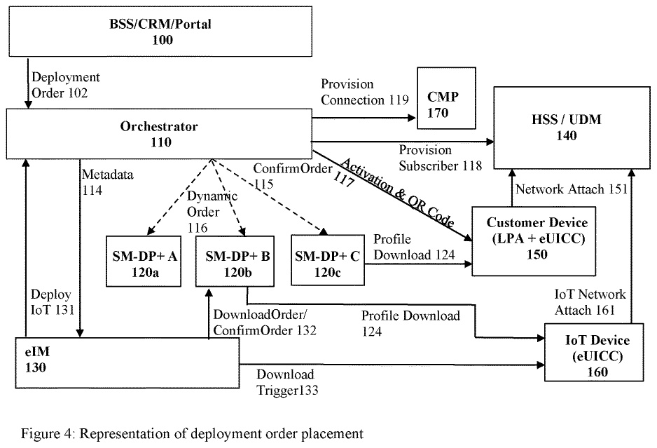

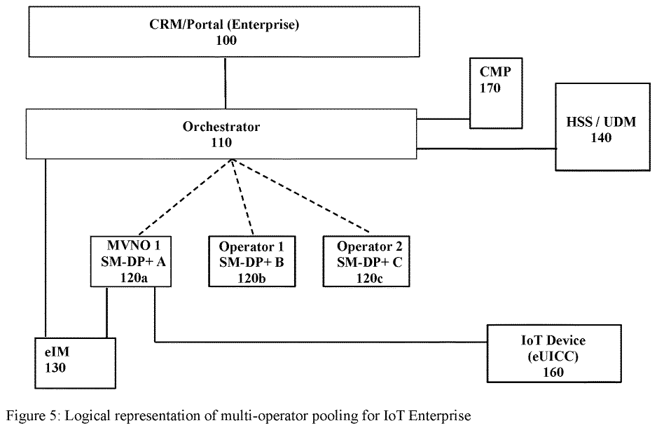

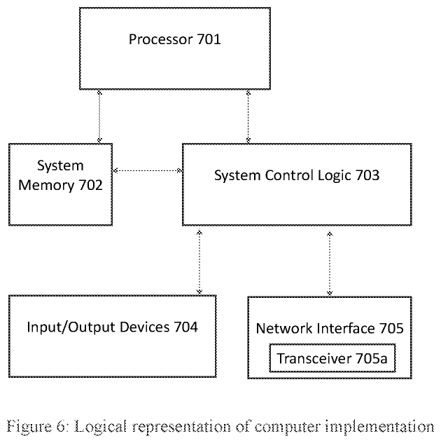

### DETAILED DESCRIPTION OF THE INVENTION

The orchestrator executes on at least one processor and provides a neutral layer between operator systems (BSS/CRM/portal) and multiple SM-DP+ servers. It receives bulk profile procurement requests and applies a policy engine to select SM-DP+ servers based on criteria such as inventory, region, cost, latency or service-level agreements. The orchestrator issues DownloadOrder and ConfirmOrder messages to allocate profiles, storing only metadata in a logical pool—excluding cryptographic keys or profile payloads to preserve GSMA security boundaries. Deployment requests trigger allocation from the pool (reference-based or dynamic fallback) with deferred HSS/UDM provisioning. For consumer activations it encodes metadata including the SM-DP+ information in string, activation codes or QR codes; for IoT it returns metadata to the eIM for remote handling. While certain messages described herein may include optional parameters or metadata, it will be understood that the corresponding functionality may also be achieved in scenarios where such parameters are omitted or where their intended purpose can be inferred from the provided subset. Unless otherwise stated, references to interfaces such as ES2+, ES8+, ES9+, ES11, ES12, and ESipa refer to interfaces defined by GSMA remote SIM provisioning specifications. A person of ordinary skill in the art will recognize that specific GSMA message names and flows are illustrative and may vary across specification versions without departing from the invention.

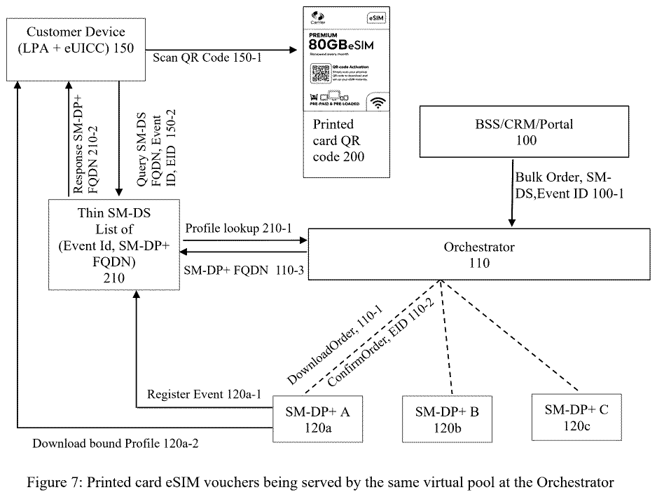

Hybrid Consumer Activation with Pre-Printed QR Vouchers—As shown in FIG. 7, in offline/retail distribution scenarios, bulk profile procurement requests (FIG. 7, 100-1) for printed batches optionally include SM-DS FQDN and a shared EventID parameter. Alternatively, these could be configured directly at the orchestrator. The orchestrator issues DownloadOrder with EventID to selected SM-DP+ servers per policy (FIG. 7, 110-1). Compliant SM-DP+ servers create eSIM profiles and automatically register event records via ES12 to the specified SM-DS using the shared EventID (FIG. 7, 120a-1) while retaining their own object identifiers and matching identifiers. As described earlier the created profiles are unbound (in pending state). The orchestrator stores the resulting metadata and matching identifiers in the uniform logical pool. Static pre-printed QR codes encode an activation code containing the SM-DS FQDN and the shared EventID; they do not embed a direct SM-DP+ address or matching identifier.

Upon scanning a pre-printed voucher (FIG. 7, 150-1), the device's LPA issues an ES11 query to the SM-DS with the EventID and the device's EID (FIG. 7, 150-2). The SM-DS (acting as a thin GSMA-compliant front-end) uses a secure internal API to the orchestrator (FIG. 7, 210-1). In response, the orchestrator's policy engine identifies an optimal eSIM profile record from the set of event records registered under that EventID (for example, based on lowest cost or latency). The orchestrator then issues a GSMA ConfirmOrder to the selected SM-DP+ server, including the device's EID, to bind the selected eSIM profile to that device in real time (FIG. 7, 110-2). This late binding ensures the profile is associated with the specific device at the moment of activation.

After binding the profile, the orchestrator returns a compliant PendingEvent response to the SM-DS (FIG. 7, 110-3). The response includes the address (FQDN) of the selected SM-DP+ server and the matching eSIM profile identifier (activation code) needed for download (FIG. 7, 210-2). If multiple profiles were registered for the shared EventID, the response may also include a prioritized list of alternate SM-DP+ server addresses and identifiers for failover.

Upon receiving the response from the SM-DS, the device's LPA connects to the specified SM-DP+ server and downloads the eSIM profile via the standard GSMA interfaces (ES8+/ES9+) (FIG. 7, 120a-2). The profile is installed on the device's eUICC, and the device can then activate it. Subscriber provisioning in the operator's core network (e.g., updating the HSS/UDM) is performed after the profile is successfully allocated to the device, avoiding the creation of unused subscriber records.

In various embodiments, the orchestrator 120 (or subscription-management system) coordinates preparation of one or more bound profile packages for a target eUICC having a specific EID. In some embodiments, the orchestrator instructs a single SM-DP+ server (or a geo-redundant cluster appearing as a single logical SM-DP+) to prepare a bound profile package bound to the EID. Upon initiation of profile download by the device, the device connects to that SM-DP+ and downloads the prepared package if available.

In one embodiment, for enhanced fail-over resilience across distinct infrastructure providers or geographically separate systems, the orchestrator instructs a plurality of distinct SM-DP+ servers to each prepare a bound profile package for the same subscription and the same target EID. Each bound profile package is cryptographically bound to the same EID and contains equivalent subscription data. The device is configured to initiate download from one of the SM-DP+ servers (for example via a primary address, load-balanced discovery or sequential fallback). Upon successful download and installation from any one of the plurality of SM-DP+ servers, the device completes the provisioning process and does not attempt further downloads for that profile order. To manage resources and prevent accumulation of unused bound profile packages, the system reclaims the unused packages on the non-utilized SM-DP+ servers. In some implementations, upon successful profile installation, the successful SM-DP+ notifies the orchestrator (directly or via standard RSP notification mechanisms). The orchestrator then issues administrative commands to the remaining SM-DP+ servers to delete or invalidate their respective unused bound profile packages. Alternatively or additionally, each prepared bound profile package may have an associated validity period or timeout; if the download is not initiated within the period, the package automatically expires and is deleted or marked unavailable by the respective SM-DP+. Periodic back-end cleanup processes may also identify and remove pending bound profile packages not associated with recent download activity. This multi-SM-DP+ embodiment provides additional redundancy without compromising security, as each bound profile package remains usable only by the target eUICC having the matching EID, and credentials never leave the protected SM-DP+ environment until successfully downloaded.

By selecting and binding the profile at the time of voucher redemption, the system prevents eSIM inventory from being statically tied to vouchers that may never be used. The orchestrator leverages the same policy criteria for voucher redemptions as it does for on-demand activations, ensuring optimal load balancing across profile pools. The inclusion of a failover list further improves reliability by allowing the device to try an alternate SM-DP+ if the first selection fails.

This hybrid voucher activation approach remains fully compliant with GSMA SGP.22 standards. The use of the SM-DS for event discovery and selection relies on standardized GSMA interfaces (ES11/ES12) and attested data from participating SM-DP+ servers. The SM-DS-based late binding mechanism is enabled on an opt-in basis for designated printed batches, preserving the traditional direct activation code workflow for online eSIM orders that do not use vouchers. This voucher-based mechanism enables runtime dynamism without stranding inventory, shares the same logical pool and policy engine as online activations and is designed to operate in accordance with GSMA SGP.22 via attested ES12 provenance. It preserves direct online activations for on-demand QR codes; the SM-DS feature is opt-in per printed batch.

The orchestrator can also segregate and analyze activation metrics by activation type. For example, it may track the redemption rates and performance of pre-printed voucher activations versus real-time online activations. These analytics, combined with the cross-vendor data, inform inventory management and policy updates. Additionally, policy rules can be tailored for specific voucher campaigns or batches (for instance, to accommodate regional or seasonal demand fluctuations), further optimizing profile allocation strategies. This innovation allows service providers to introduce vouchers in response to customer demand rather than being limited by isolated voucher eSIM inventory.

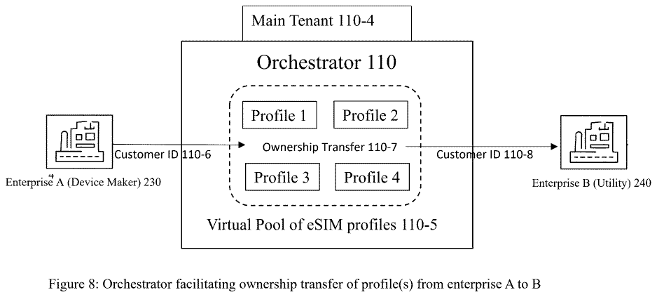

Multi-Tenant IoT Ownership Transfer and Handover. In IoT supply-chain handover scenarios, the orchestrator operates as a multi-tenant platform. A tenant refers to any entity that interacts with the orchestrator to procure, manage, or transfer products or services facilitated by the orchestrator, either directly or under the orchestration authority of another entity. This includes, but is not limited to, device manufacturers, deploying enterprises, service providers, or utilities that may possess dedicated logical pools or operate as customers of another tenant. A main tenant refers to the primary platform licensee or operator (e.g., a connectivity provider) that administers the orchestrator instance and may onboard and delegate certain operations orchestration to other tenants or customer entities within its administrative domain. As shown in FIG. 8, a main tenant (e.g., a connectivity provider) hosts the orchestrator (110-4). While this scenario is described with a connectivity provider as the main tenant, it will be apparent to a person skilled in the art that other entities, including a device manufacturer or a device user, may alternatively serve as the main tenant without departing from the scope of the invention.

A device manufacturer (FIGS. 8, 230) having a business relationship with the main tenant, uses an orchestrator portal to order unbound bootstrap profiles and eUICC hardware. These bootstrap profiles provide initial connectivity for the devices out of the box, typically offering generic or global network access. The orchestrator, following its policy rules, selects one or more SM-DP+ vendors to supply the bootstrap profiles. The orchestrator issues DownloadOrder commands to selected SM-DP+ servers to prepare unbound bootstrap profiles and it then stores metadata (EID/ICCID manifest, batch number) in a virtual pool (FIG. 8, 110-5) associated with ordering enterprise ID (FIG. 8, 110-6). The device manufacturer installs the allocated bootstrap profiles onto the eUICCs of its devices during production. Once the devices are provisioned with bootstraps and fully assembled, they are shipped to a downstream customer, for example, a utility company (FIGS. 8, 240) that will operate the devices. At this stage, each device carries a bootstrap profile that is technically active (allowing connectivity) but is still associated with the manufacturer's eSIM management account. The device manufacturer issues a transfer order via the portal (FIG. 8, 110-7); the orchestrator onboards the downstream enterprise as a new tenant on main tenant's behalf and transfers the bootstrap profile references and associated metadata to the new entity's logical pool (FIG. 8, 110-8) without re-preparation or key movement.

After the transfer, the new tenant (utility) assumes management of the devices and their eSIM profiles. When a transferred device is powered on, it uses the pre-installed bootstrap profile to connect to the network (often through the connectivity provider's infrastructure associated with the bootstrap) to reach and register with its associated eSIM IoT Manager (eIM).

The new tenant orders operational profiles via its portal; the orchestrator issues a pending DownloadOrder to allocate each operational profile and stores metadata. The orchestrator transmits operational metadata to the new tenant's eIM. The eIM issues a ConfirmOrder using the device's EID to perform late binding and sends a DownloadTrigger; the device downloads and installs the operational profile and switches to local connectivity. This handover mechanism enables seamless supply-chain decoupling, allowing device makers to use a global bootstrap while utilities obtain local operational profiles without re-preparing eSIM profiles.

Global eSIM profile providers often do not know where a device will ultimately be deployed. To address this, they may provide multi-IMSI profiles or include applets that dynamically select from among various partner networks to achieve near-universal coverage and best roaming rates. The orchestrator can accommodate such globally provisioned bootstrap profiles within its logical pool and policy framework.

In some embodiments, the initial Bootstrap profile may also be capable of supporting operational connectivity for a limited or full period (e.g., during initial deployment or testing). However, due to regulatory or policy-driven requirements, such as mandated use of a local carrier profile, the device may later switch to a localized operational profile. This transition may occur after ownership transfer, wherein a main tenant (e.g., a global connectivity provider) pre-stages one or more localized operational profiles in the orchestrator. These profiles may then be allocated to the second enterprise tenant during deployment or activation, enabling runtime compliance without requiring re-provisioning or bootstrap replacement. The orchestrator supports these scenarios by enabling profile ownership transfer mechanisms and profile swap workflows that give end users control over profiles after purchase, integrating with provider systems to seamlessly shift profile management and subscription billing to the end user.

This multi-tenant handover process—illustrated in FIG. 8—allows eSIM profiles to be transferred between different enterprise accounts without duplicating provisioning steps. The device manufacturer is able to utilize a global bootstrap profile during production, and the utility is able to later provide each device with a locally-optimized operational profile through late binding. Because profiles are prepared only once and simply reassigned, the handover avoids redundant profile preparation and significantly streamlines the supply chain. It also ensures compliance with regulatory requirements by delivering local profiles only when and where needed, under the control of the appropriate enterprise.

1. A method for pre-printed QR voucher activation, comprising:
(a) receiving a bulk profile procurement request that includes a Subscription Manager Discovery Server (SM-DS) fully qualified domain name (FQDN) and a shared EventID;
(b) causing automatic ES12 event registration from selected SM-DP+ servers to the SM-DS;
(c) printing static QR codes encoding the SM-DS FQDN and the shared EventID;
(d) responsive to a device scanning the QR code and initiating an ES11 query to the SM-DS with the shared EventID and a device eUICC identifier (EID), selecting an eSIM profile from registered records using a policy engine and issuing a ConfirmOrder to a selected SM-DP+ server to bind the selected profile to the EID; and
(e) returning a compliant response via the SM-DS including a selected SM-DP+ FQDN and a matching identifier.

2. The method of claim 1, wherein selection at query time applies policy criteria used for non-voucher-based eSIM profile activations to enable runtime load balancing and failover from the logical profile pool.

3. The method of claim 1, wherein the SM-DS parameter is configurable on a per-batch basis for voucher-based activations.

4. The method of claim 1, wherein the SM-DS comprises a thin front-end with an internal API to the orchestration platform for policy-based selection.

5. The method of claim 1, wherein the orchestrator instructs a plurality of distinct subscription manager data preparation (SM-DP+) servers to each prepare a bound profile package bound to the same eUICC identifier (EID), for a profile activation to enable the device to obtain the bound profile package from an alternate SM-DP+ server if a first SM-DP+ server is unavailable or unreachable; wherein the device downloads the bound profile package from one of the plurality of SM-DP+ servers; and wherein, upon successful download and installation, any unused bound profile packages on remaining SM-DP+ servers are reclaimed by deletion initiated by the orchestrator upon notification of successful installation, by automatic expiration based on a validity period or timeout, or by administrative cleanup.

6. The method of claim 1, wherein the shared EventID enables multi-SM-DP+ registration under a single voucher batch.

7. A system for eSIM profile lifecycle orchestration, comprising: one or more processors; and a memory storing instructions that, when executed by the one or more processors, cause the system to perform the method of claim 1.

8. A method for multi-tenant ownership transfer of eSIM profiles, comprising:
(a) receiving a profile order from a first tenant;
(b) preparing unbound eSIM profiles and storing associated references and metadata, including EID/ICCID manifest and batch number information, in a logical pool;
(c) receiving a transfer order from the first tenant;
(d) onboarding a second enterprise as a tenant; and
(e) transferring the profile references and metadata to a logical pool associated with the second tenant without re-preparation of the eSIM profiles.

9. The method of claim 8, wherein the eSIM profiles comprise bootstrap profiles provisioned to provide initial device connectivity prior to provisioning of an operational profile.

10. The method of claim 8, wherein the eSIM profiles comprise operational profiles provisioned for ongoing service after initial device connectivity.

11. The method of claim 8, wherein the first tenant and the second tenant are associated with different enterprise entities managed either as separate tenants or as customers within a tenancy hierarchy of the orchestration platform.

12. The method of claim 8, wherein subsequent profile orders from the second tenant use transferred references for runtime late binding using ConfirmOrder and DownloadTrigger.

13. The method of claim 8, wherein the transferred metadata includes EID/ICCID manifest data for inventory management.

14. The method of claim 8, wherein the transfer enables supply-chain handover from global bootstrap connectivity to localized operational profiles.

15. The method of claim 8, wherein ownership transfer enables the second tenant to perform billing, policy control, or service extension associated with the transferred profiles.

16. The method of claim 8, wherein a switch to a localized operational profile is triggered by a regulatory, policy, or commercial requirement.

17. A system for eSIM profile lifecycle orchestration, comprising: one or more processors; and a memory storing instructions that, when executed, cause the system to perform the method of claim 8.

18. A non-transitory computer-readable medium storing instructions that, when executed by one or more processors, cause one or more processors to perform a method comprising: preparing unbound eSIM profiles in a logical pool and transferring profile references between tenants without re-preparation.

19. The system of claim 17, wherein the orchestrator maintains enterprise-specific logical pools of eSIM profiles corresponding to different enterprise customers, such that profiles procured for a particular enterprise are segregated into that enterprise's pool and transferable to another enterprise's pool without re-preparation.

20. The method of claim 1, wherein profile binding is performed on pre-prepared pending profiles to reduce provisioning latency.
